(19) United States
(12) Patent Application Publication
(10) Pub. No.: US 2014/0359984 A1
(43) Pub. Date: Dec. 11, 2014

(54) METHOD OF MANUFACTURING LIQUID EJECTING DEVICE

(71) Applicant: CANON KABUSHIKI KAISHA, Tokyo (JP)

(72) Inventors: Ryota KASHU, Kawasaki-shi (JP); Toru Nakakubo, Kawasaki-shi (JP)

(73) Assignee: CANON KABUSHIKI KAISHA, Tokyo (JP)

(21) Appl. No.: 14/292,092

(22) Filed: May 30, 2014

(30) Foreign Application Priority Data
Jun. 5, 2013 (JP) 2013-118726

(51) Int. Cl. B41J 2/16

(52) U.S. Cl. CPC B41J 2/1607
USPC 29/25.35

(57) ABSTRACT

A liquid ejecting device is manufactured by bonding a wiring substrate to a liquid ejection head by means of an adhesive film. The liquid ejection head has a pressure chamber for ejecting liquid and an air chamber disposed adjacent to the pressure chamber with a wall of a piezoelectric body interposed therebetween. A pair of electrodes is provided, one on the wall surface of the pressure chamber and the other on the wall surface of the air chamber so as to sandwich the piezoelectric body wall. The wiring substrate has a connection terminal which is to be electrically connected at least to the electrode on the pressure chamber side at the time of bonding. The liquid ejection head has an opening for introducing liquid into the pressure chamber, while the wiring substrate has a through hole to be aligned with the opening at the time of bonding.

### BACKGROUND OF THE INVENTION

1. Field of the Invention

The present invention relates to a method of manufacturing a liquid ejecting device for ejecting liquid such as ink (to be simply referred to as ink hereinafter).

2. Description of the Related Art

Known recording apparatus include Inkjet recording apparatus designed to record images on recording mediums by ejecting ink. An inkjet head for ejecting ink is mounted in the inkjet recording apparatus.

Known mechanisms for ejecting ink in inkjet heads include those that are designed to change the capacity of the pressure chamber contained in the inkjet head by means of a piezoelectric material, which is typically PZT (Pb(Zr, Ti)O₃: lead zirconate titanate), in order to introduce ink and eject it. The pressure chamber is held in communication with an ink feed path for feeding the pressure chamber with ink and an ejection port for ejecting ink from the pressure chamber. As the volume of the pressure chamber is contracted, the ink in the pressure chamber is ejected out of the ejection port as ink droplets. As the volume of the pressure chamber is expanded, on the other hand, ink is introduced into the pressure chamber from the ink feed path.

There has been an increasing demand in recent years for inkjet recording apparatus that can record high quality images at high speed. To realize such an apparatus, a large number of nozzles need to be arranged highly densely and a large number of wires need to be drawn out to drive the members of a piezoelectric material that correspond to the respective nozzles. Then, there arise a problem of difficulty of wiring and also a problem of increase in the number of parts including FPCs (flexible printed circuits) and connectors.

To solve these and other problems, a technique of using a wiring substrate that is provided with extraction wiring, drive circuits and ink paths and connected to an inkjet head so as to extract wiring to the outside of the inkjet head has been proposed (International Publication No. WO2011/005699).

With the technique described in International Publication No. WO2011/005699, solder bumps are employed to establish electrical connection between the inkjet head and the wiring substrate at the connecting section of the inkjet head and the wiring substrate and a polymer structure is formed to ensure airtightness of the ink path. However, because a polymer structure does not represent any adhesiveness, an adhesive agent is sprayed and applied to the entire bonding surface of the wiring substrate and that of the inkjet head so as to bond the wiring substrate to the inkjet head. With the above-described technique, however, the adhesive agent can penetrate into and block at least some of the ink paths. If the adhesive agent is applied by means of a dispenser or by transfer, there remains a problem that the adhesive agent can be forced to get into some of the ink paths to make it difficult to manufacture such inkjet head and wiring substrate combinations on a stable and reliable basis.

Additionally, when arranging nozzles highly densely with the ink path design described in International Publication No. WO2011/005699, the polymer structure needs to be formed so as to be highly accurately in alignment with the ink paths. Such a requirement of highly accurate alignment may be met only at the cost of productivity.

Japanese Patent Application Laid-Open No. 2002-086741 describes a method of electrically connecting a shear mode type inkjet head with a mounting substrate (wiring substrate) by means of bumps and filling the gap between the inkjet head and the mounting substrate with an adhesive agent, utilizing capillary force. The applicant claims that the adhesive agent filled into the gap is not forced to get into the ink path due to the size relationship between the cross-sectional area of the ink paths formed in the inkjet head and the cross-sectional area of the through holes in the mounting substrate that are formed at positions that correspond to the ink paths. However, with this method, the cross-sectional area of each of the through holes in the mounting substrate needs to be made greater than the cross-sectional area of each of the ink paths. Therefore, this method entails a problem of reducing the area on the mounting substrate for forming a wiring pattern. This method additionally entails a problem that, if dirt or the like adheres to the bonding surfaces of the mounting substrate and that of the inkjet head at positions located near the ink paths, the adhesive agent can be forced into at least some of the ink paths. If the adhesive agent is forced to get to the inner walls of the ink paths even by a small quantity, the ink paths can entirely be filled with the adhesive agent.

### SUMMARY OF THE INVENTION

According to the present invention, the above identified problems are dissolved by providing a method of manufacturing a liquid ejecting device equipped with a liquid ejection head including a pressure chamber communicating with an ejection port for ejecting liquid and having an opening for introducing ink to be ejected from the ejection port and a plurality of air chambers separated from the pressure chamber, a piezoelectric body being arranged between the pressure chamber and at least one of the air chambers, a pair of electrodes being provided, one formed on the wall of the pressure chamber and the other formed on the wall of the at least one of the air chambers so as to sandwich the piezoelectric body, the liquid ejection head being so constructed as to eject liquid from the ejection port by applying a voltage between the pair of electrodes and causing the piezoelectric body to expand and contract, the method including: bonding a wiring substrate having a connection terminal to be electrically connected to the electrode formed on the wall of the pressure chamber, wiring extending from the connection terminal and a through hole representing a cross-sectional area smaller than the cross-sectional area of the opening and formed at a position corresponding to the opening to a bonding surface of the liquid ejection head arranged at the side of the opening by means of an adhesive film; and electrically connecting the connection terminal of the wiring substrate and the electrode formed on the wall of the pressure chamber of the liquid ejection head.

Further features of the present invention will become apparent from the following description of exemplary embodiments with reference to the attached drawings.

### BRIEF DESCRIPTION OF THE DRAWINGS

FIG. 1 is a schematic illustration of an inkjet recording apparatus formed by using an inkjet device produced by means of an embodiment of the present invention.

FIG. 2 is a schematic plan view of an inkjet device mounted in the inkjet recording apparatus of FIG. 1, illustrating the positional arrangement of the ejection ports thereof.

FIG. 3 is an exploded schematic perspective view of the inkjet device of FIG. 2.

FIG. 4 is a schematic perspective view of the inkjet head illustrated in FIG. 3, illustrating the configuration thereof.

FIGS. 5A and 5B are schematic cross-sectional partial views of the inkjet head of FIG. 4, illustrating how the inkjet head is driven to operate.

FIGS. 6A and 6B are schematic cross-sectional partial views of an inkjet head and a wiring substrate, illustrating steps of bonding the inkjet head and the wiring substrate in Example 1 of the manufacturing method according to the present invention.

FIGS. 7A and 7B are schematic cross-sectional partial views of an inkjet head and a wiring substrate, illustrating steps of bonding the inkjet head and the wiring substrate in Example 2 of the manufacturing method according to the present invention.

FIGS. 8A, 8B, 8C and 8D are schematic cross-sectional partial views of an inkjet head and a wiring substrate, illustrating steps of bonding the inkjet head and the wiring substrate in Example 4 of the manufacturing method according to the present invention.

FIGS. 9A and 9B are schematic cross-sectional partial views of an inkjet head and a wiring substrate, illustrating that one or more than one of the connection terminals can be broken at the time of bonding the inkjet head and the wiring substrate.

FIGS. 10A, 10B, 10C and 10D are schematic cross-sectional partial views of an inkjet head and a wiring substrate, illustrating alternative steps of bonding the inkjet head and the wiring substrate in Example 4 of the manufacturing method according to the present invention.

FIGS. 11A, 11B, 11C and 11D are schematic cross-sectional partial views of an inkjet head and a wiring substrate, illustrating steps of bonding the inkjet head and the wiring substrate in Example 5 of the manufacturing method according to the present invention.

FIG. 12 is a schematic cross-sectional partial view of an inkjet head and a wiring substrate, illustrating how the inkjet head and the wiring substrate are bonded by way of alternative bonding steps in Example 5 of the manufacturing method according to the present invention.

FIG. 13 is a schematic cross-sectional partial view of an inkjet head and a wiring substrate, illustrating how the inkjet head and the wiring substrate are bonded by way of still other alternative bonding steps in Example 5 of the manufacturing method according to the present invention.

FIG. 14 is a schematic cross-sectional partial view of an inkjet head and a wiring substrate, illustrating the pedestal structure formed on the wiring substrate in Example 6 of the manufacturing method according to the present invention.

### DESCRIPTION OF THE EMBODIMENTS

Now, the present invention will be described in greater detail below by referring to the accompanying drawings that illustrate an embodiment of the present invention. Note that the present invention is not limited to the embodiment by any means.

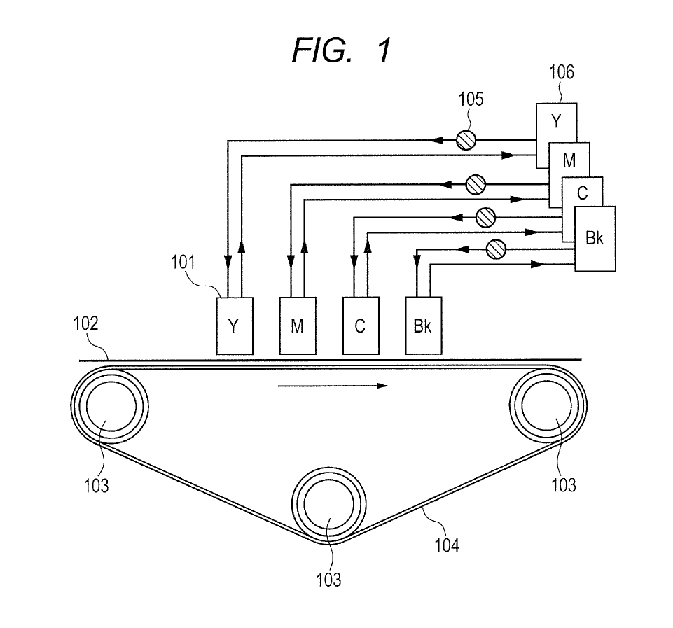

FIG. 1 is a schematic illustration of an exemplar configuration of an inkjet recording apparatus that is suitably designed to execute an inkjet recording method, using inkjet devices produced by means of an embodiment of manufacturing method of the present invention. The inkjet recording apparatus comprises conveyor rollers 103 and a conveyor belt 104, which is an endless belt tightly wound around the conveyor rollers 103 to convey a recording medium 102 that is laid thereon. As the inkjet recording apparatus drives the conveyor belt 104 to move, the recording medium 102 is conveyed in the direction indicated by the arrow illustrated in FIG. 1.

With the exemplar configuration illustrated in FIG. 1, inkjet devices 101 are employed in it. Additionally, with the exemplar configuration illustrated in FIG. 1, four liquid ejection heads, which are inkjet heads 303, are arranged in the direction of conveying the recording medium 102 so as to respectively accommodate four different color inks (liquids) of, for example, yellow (Y), magenta (M), cyan (C) and black (Bk). The inkjet devices 101 operate for full color recording at high speed by ejecting different color inks as the recording medium 102 is being conveyed.

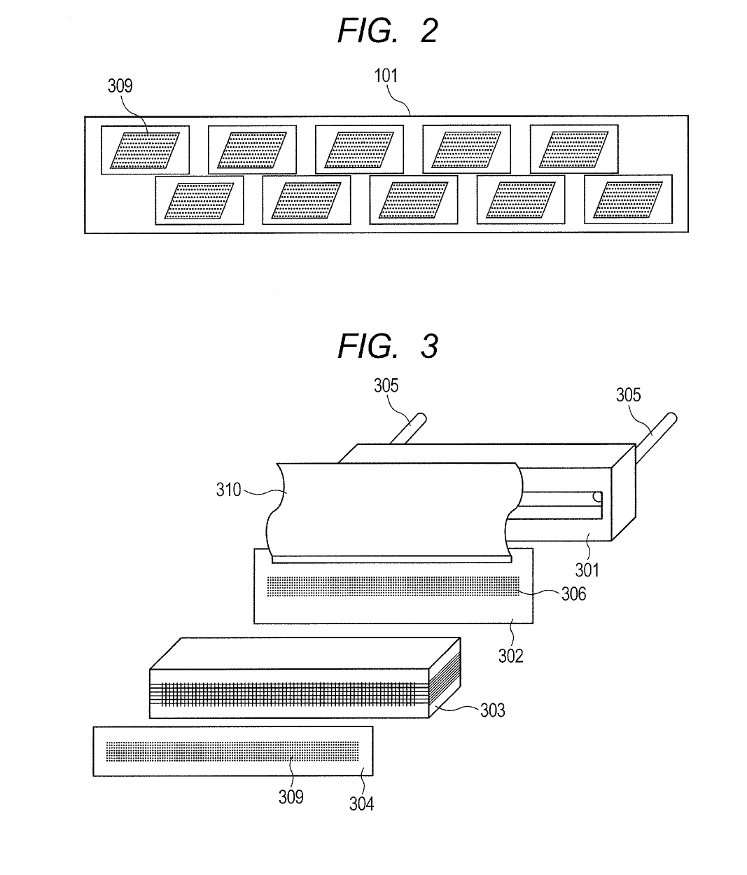

FIG. 2 illustrates the positional arrangement of the ejection ports 309 of one of the inkjet devices 101. The inkjet devices 101 provided for different color inks are structurally identical with each other.

As illustrated in FIG. 2, a short and compact inkjet head 303 is realized by densely arranging ejection ports 309 for ejecting ink droplets. The ejection ports 309 are arranged to form a two dimensional arrays. Then, a long full line head is formed by linking a plurality of short and compact inkjet heads 303 so as to cover the entire width of the recording medium 102.

Now, the configuration of the inkjet devices 101 mounted in the inkjet recording apparatus of the present embodiment will be described below.

FIG. 3 is an exploded schematic perspective view of one of the inkjet devices 101, which are same and identical with each other. As illustrated in FIG. 3, the inkjet device 101 is formed by sequentially laying an orifice plate 304, an inkjet head 303, a wiring substrate 302 and a common liquid chamber 301 and bonding them together. The wiring in the wiring substrate 302 and the electrodes in each of the ink paths of the inkjet head 303 are electrically connected to each other. The wiring that is to be drawn out to the outside is actually drawn out from the inkjet head 303 by means of a flexible cable 310 and by way of the wiring substrate 302.

The orifice plate 304 is provided with ejection ports 309 for ejecting pressurized ink as liquid droplets.

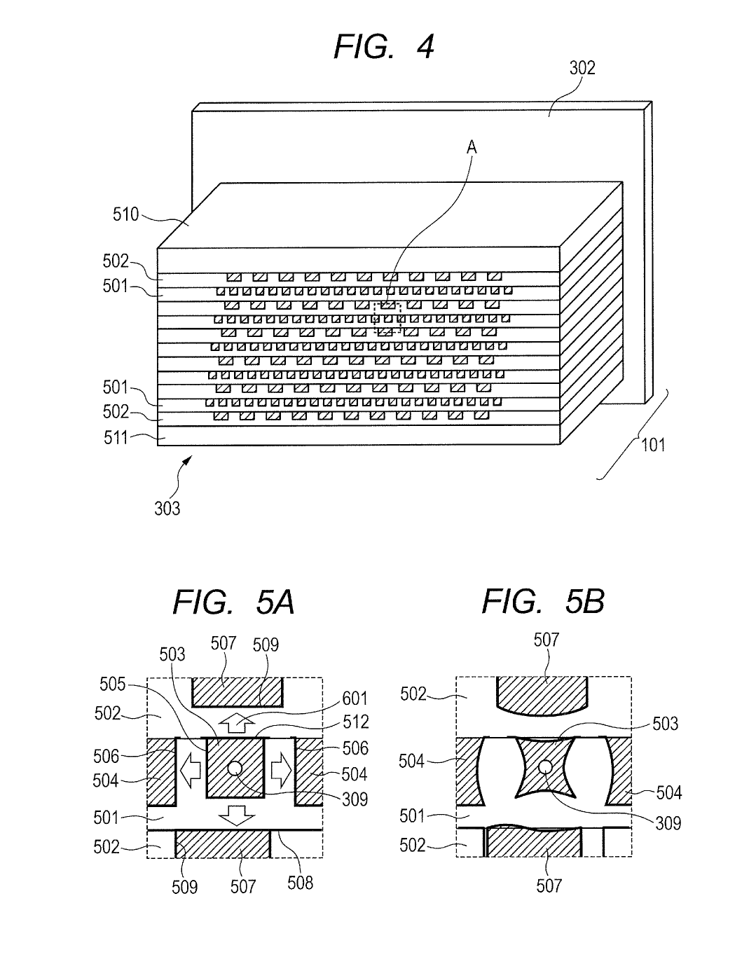

Now, the configuration of the inkjet head 303 will be described below. FIG. 4 illustrates the components of the inkjet head 303. The inkjet head 303 is formed by laying a first support substrate 510, a second support substrate 511, the first support substrate 510 and the second support substrate 511 operating as top plate and bottom plate respectively, first piezoelectric plates 501 and second piezoelectric plates 502, the first piezoelectric plates 501 and the second piezoelectric plates 502 being so many piezoelectric bodies, and bonding them together. The first support substrate 510 and the second support substrate 511 are flat and plain plates on which no pattern or the like is formed. The first support substrate 510 and the second support substrate 511 do not need to be formed by using so many piezoelectric bodies. However, the first support substrate 510 and the second support substrate 511 are preferably made of a material that represents a thermal expansion coefficient close to that of the first piezoelectric plates 501 and the second piezoelectric plates 502 if they need to be heated at the time of being bonded together.

Now, the wiring substrate 302 will be described below by referring to FIG. 3. The wiring substrate 302 is provided with through holes, which operate as so many ink paths, at positions corresponding to the respective pressure chambers 503 (see FIGS. 5A and 5B). The inkjet head 303 is electrically connected to the drive circuit IC of the piezoelectric actuator that is formed in the wiring substrate 302. Additionally, the wires that the wiring substrate 302 has are electrically connected to respective connection terminals 702, which will be described in greater detail hereinafter, and also to the control section (not illustrated) of the inkjet recording apparatus that is externally arranged by way of the flexible cable 310.

Now, the common liquid chamber 301 will be described below. The common liquid chamber 301 is provided with ink feed paths 305 for feeding ink from the related ink tanks 106 (see FIG. 1), which ink feed paths 305 are held in communication with the respective pressure chambers 503.

Now, the operation of driving the inkjet head 303 will be described below. FIGS. 5A and 5B are enlarged schematic cross-sectional views of the region A illustrated in FIG. 4. As illustrated in FIG. 5A, a plurality of pressure chambers 503 are formed in each of the first piezoelectric plates 501. Each of the pressure chambers 503 communicates with a corresponding one of the ejection ports and is adapted to store the ink ejected from the ejection port. Air chambers 504 that are simply gaps are arranged at the opposite sides of each of the pressure chambers 503 of the first piezoelectric plate 501.

A first electrode (SIG) 505 is arranged on the inner wall of each of the pressure chambers 503, while a second electrode (GND) 506 is arranged on the inner wall of each of the air chambers 504. A third electrode (GND) 508 is formed on the entire rear surface of each of the first piezoelectric plates 501, which rear surface is the surface opposite to the surface thereof at which pressure chambers 503 are directly disposed. On the other hand, air chambers 507 are formed in each of the second piezoelectric plates 502 at positions corresponding to the positions where pressure chambers 503 are formed in the adjacently located one of the first piezoelectric plates 501 and a fourth electrode (GND) 509 is formed on the entire inner surfaces found in the second piezoelectric plate 502 including the inner surfaces of the air chambers 507. Additionally, a fifth electrode (SIG) 512 is formed on the rear surface of the second piezoelectric plate 502 at each position that corresponds to a pressure chamber 503 in the piezoelectric plate 501, which rear surface is the surface opposite to the surface at which air chambers 507 are directly disposed.

Each of the pressure chambers 503 is surrounded by air chambers 504, 507 that are arranged around it. Actually, pressure chambers 503 are arranged in a plurality of rows so as to form a two dimensional array. The partition wall of each of the pressure chambers 503 is polarized in polarization directions 601 that are outwardly pointed from the pressure chamber 503. FIG. 5B illustrates how a pressure chamber 503 and the surrounding air chambers 504, 507 appear when a drive voltage is applied to the related electrodes. Note that the displacement of the partition wall is exaggeratedly illustrated in FIG. 5B for the purpose of easy understanding. When a drive voltage is applied, the first electrode (SIG) 505 formed on the inner wall of the pressure chamber 503 and the fifth electrode (SIG) 512 are made to represent a positive potential level, while the second electrodes (GND) 506 formed on the inner walls of the air chambers 504, 507, the third electrode (GND) 508 and the fourth electrode (GND) 509 are made to represent the GND potential level. As a voltage is applied between the electrodes at a positive potential level and the electrodes at the GND potential level, the partition wall of the pressure chamber 503 is deformed to contract the pressure chamber 503. As the pressure chamber 503 is contracted, the pressure of the ink filled in the pressure chamber 503 is raised to eject ink droplets from the ejection port 309. In a similar manner, a different drive voltage is applied between the electrodes so as to make the first electrode (SIG) 505 and the fifth electrode (SIG) 512 represent the GND potential level and the second electrode (GND) 506, the third electrode (GND) 508 and the fourth electrode (GND) 509 represent a positive potential level. Then, the partition wall of the pressure chamber 503 is elongated to expand the pressure chamber 503 (although not illustrated) so that ink is fed into the pressure chamber 503.

While pressure chambers 503 and air chambers 507 are formed respectively in the first and second piezoelectric plates 501, 502 that are made of a piezoelectric material and the pressure chambers 503 and the air chambers 507 are separated by piezoelectric bodies in the above-described inkjet devices that are manufactured by the method of the present invention, the present invention is by no means limited to the above-described arrangement. Note that ink can be ejected when, according to need, a piezoelectric body is arranged between at least an air chamber and pressure chambers that surround the air chamber.

The technique of bonding an inkjet head 303 and a wiring substrate 302 for an inkjet device to be manufactured by the method of present invention will specifically be described below by way of examples.

### Example 1

Now, the method of bonding an inkjet head 303 and a wiring substrate 302 according to the present invention will be described in detail by way of Example 1.

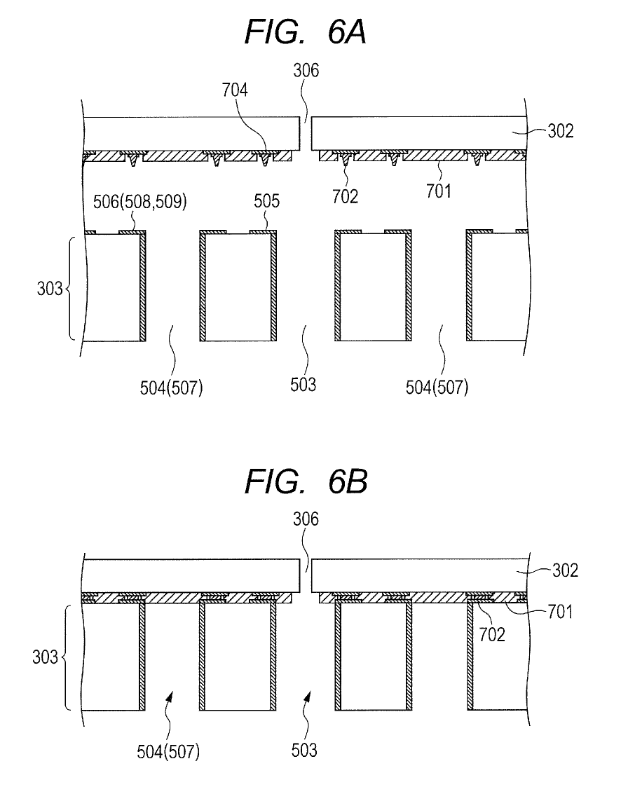

FIGS. 6A and 6B are schematic cross-sectional partial views explaining the manufacturing method related to Example 1. As illustrated in FIG. 6A, a pattern of adhesive film 701 is formed on the wiring substrate 302 and subsequently connection terminals 702 are formed also on the wiring substrate 302. Through holes 306 are formed through the wiring substrate 302 at positions corresponding to respective pressure chambers 503. The cross-sectional area of each of the through holes 306 is smaller than the cross section area of the opening of each of the pressure chambers 503. The pattern of the adhesive film 701 is formed so as to avoid the areas occupied by the through holes 306 and the connection terminal pads 704. Then, the connection terminals 702 are formed on the respective connection terminal pads 704. The height of the connection terminals 702 needs to be greater than the thickness of the adhesive film 701 as viewed in the thickness direction of the wiring substrate 302.

Then, as illustrated in FIG. 6B, the wiring substrate 302, on which the connection terminals 702 have been formed by means of the pattern of the adhesive film 701, is bonded to the bonding surface of the inkjet head 303 that is the surface opposite to the surface where ejection ports are formed. Note that, at this time, the wiring substrate 302 and the inkjet head 303 are bonded to each other by way of the adhesive film 701 in such a way that the connection terminals 702 are electrically connected to the respective corresponding electrodes 505, which are individual electrodes, and also to the electrodes 506, 508 and 509 that are common electrodes. Thus, the height of the connection terminals 702 after the bonding operation is substantially determined by the thickness of the adhesive film 701.

The adhesive film 701 is a film-shaped adhesive agent such as photoresist on which a pattern can be formed. By using such adhesive film 701, a situation where the adhesive agent is forced to get into some of the ink paths can be prevented from taking place. Since the adhesive film 701 is made of a filmy material, the adhesive agent of the adhesive film 701 can be made to represent a uniform thickness even at locations near the through holes 306.

Adhesive film 701 that can be used for the purpose of the present invention include die attach film DF Series and KA Series available from Hitachi Chemical Co., Ltd. and TMMF, which is dry film resist, available from Tokyo Ohka Kogyo Co., Ltd. Any of the above cited adhesive film products is adhesive film by means of which a pattern can be formed by photo-lithography and which can be cured at a relatively low temperature between about 150° C. and about 200° C. Degradation of the piezoelectricity of the piezoelectric actuator employed in an inkjet head 303 can be minimized by using such an adhesive film product.

Preferably stud bumps that are made of Au, Ag, Cu, Al or the like are employed for the connection terminals 702 because the connection terminals 702 need to be made higher than the thickness of the adhesive film 701. If plated bumps or solder bumps are adopted, a mold (typically made of resist) needs to be employed to form such bumps and removed after forming the bumps. The adhesive film 701 can be damaged as a result of dissolution and/or swelling depending on the organic solvent that is employed to remove the mold. When the adhesive film 701 is dissolved, swollen or otherwise damaged to a considerable extent, it can come off from the wiring substrate 302 and/or the inkjet head 303. Stud bumps provide an additional advantage that they can be easily plastically deformed at the time of bonding and reliably serve for establishing electrical connections because, when compared with plated bumps and solder bumps, stud bumps represent a sharply pointed tip profile.

Specific examples of bonding methods that can be used for bonding a wiring substrate 302 and an inkjet head 303 include thermocompression and ultrasonic bonding. Ultrasonic bonding is a technique of bonding two objects together by applying a load to the objects, while vibrating the bonding area by ultrasonic waves. Therefore, the bonding area is locally heated as a result of frictions caused by ultrasonic vibrations. For this reason, in the case of ultrasonic bonding, the temperature to which the entire wiring substrate 302 is heated can be made relatively low and the load applied to the wiring substrate 302 can be made relatively small if compared with thermocompression. Furthermore, ultrasonic bonding provides an effect of cleansing the bonding surfaces due to ultrasonic vibrations. Therefore, if either or both of the bonding surfaces are slightly contaminated, they can be reliably bonded together by ultrasonic bonding.

By using the manufacturing method of the present invention that comprises bonding an inkjet head 303 and a wiring substrate 302, the electrodes of the inkjet head 303, which is made of a bulk piezoelectric body, can be drawn out to the side of the wiring substrate 302. Additionally, as the inkjet head 303 and the wiring substrate 302 are bonded to an adhesive film 701 simultaneously, the airtightness of the pressure chambers 503 and the ink paths formed by through holes 306 can be ensured. The pattern of the adhesive film 701 does not need to be formed in areas that are located very close to the through holes 306. In other words, the adhesive film 701 only needs to be patterned in areas located between the edges of the through holes 306 and the edges of the inner wall of the pressure chambers 503. Thus, the process of forming a pattern on the adhesive film 701 affords a wide margin of operation errors and can ensure a high yield. Furthermore, since the connection terminals 702 are formed on the wiring substrate 302 on which the adhesive film 701 has been patterned, the alignment of the connection terminals 702 and the adhesive film 701 is not degraded as a result of bonding the inkjet head 303 and the wiring substrate 302.

### Example 2

Now, the method of bonding an inkjet head 303 and a wiring substrate 302 according to the present invention will be described in detail by way of Example 2.

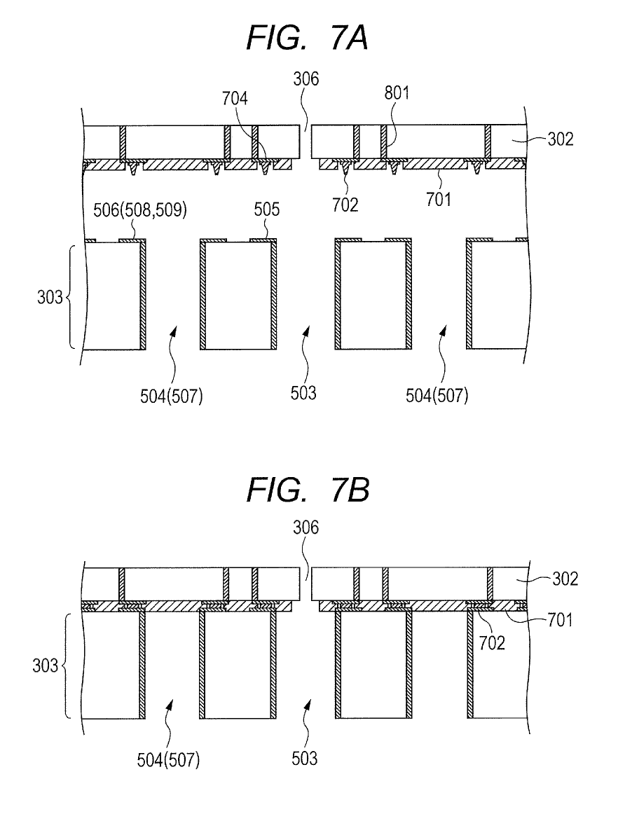

FIGS. 7A and 7B are schematic cross-sectional partial views explaining the manufacturing method related to Example 2. In Example 2, as illustrated in FIG. 7A, through electrodes 801 that are electrically connected to connection terminals 702 and connection terminal pads 704 are formed in the wiring substrate 302. Subsequently, as illustrated in FIG. 7B, the inkjet head 303 is bonded to the wiring substrate 302 on which a pattern of adhesive film 701 and the connection terminals 702 have been formed. In Example 1, the wiring that the wiring substrate 302 has is formed on the bonding surface which is the same as the surface thereof where the adhesive film 701 and the connection terminals 702 are found. In Example 2, on the other hand, the wiring of the wiring surface 302 can be drawn out to the rear surface of wiring substrate 302 that is opposite to the bonding surface of the wiring substrate 302 by means of the through electrodes 801. Since no connection terminals 702 are arranged on the rear surface of the wiring substrate 302 that is opposite to the bonding surface of the wiring substrate 302, the space on the rear surface can be utilized to form a wiring pattern so that the wiring can be formed more densely.

For forming the through electrodes 801, firstly through holes are formed by means of anisotropic etching of Si (wet etching or dry etching), laser machining, end mill machining or sand blast processing. Subsequently, the through electrodes 801 are produced as metal film is formed in the insides of the through holes by sputtering, plating or the like in order to electrically connect the electrodes on the front surface and those on the rear surface of the wiring substrate 302.

### Example 3

Now, the method of bonding an inkjet head 303 and a wiring substrate 302 according to the present invention will be described in detail by way of Example 3.

In Example 3, after bonding an inkjet head 303 and a wiring substrate 302 as in Examples 1 and 2, thin film of paraxylene polymer (to be referred to as Parylene (trade name) hereinafter) is formed on all the surfaces of bonded entity of the inkjet head 303 and the wiring substrate 302 except that no Parylene thin film is formed on the area on the wiring substrate 302 to which a flexible cable 310 is to be connected. In other words, a masking process is conducted before forming Parylene thin film.

The technique of chemical vapor-phase deposition (CVD) is employed to form Parylene thin film. The use of Parylene (N) (trade name) is advantageous when thin film needs to be formed down to remote wall ends of liquid chambers because Parylene thin film stickily spreads and penetrates into remote areas. For the purpose of the present invention, the suitable thickness of Parylene thin film is between about 5 μm and about 10 μm.

Parylene thin film is formed even on the parts of the adhesive film 701 that are exposed to the insides of some or all of the ink paths when the Parylene thin film is formed on the inkjet head 303 after bonding it with the wiring substrate 302. Parylene is a chemically very stable substance and highly resistant to chemicals so that the inkjet head 303 is made to be able to eject liquid that can otherwise dissolve and/or erode the adhesive film 701. Furthermore, even a slight gap is produced between the adhesive film 701 and the inkjet head 303, the gap can be closed by filling it with Parylene. Therefore, the durability of the inkjet head 303 is improved and a broader range of ink materials can be used with the inkjet head 303 by forming Parylene thin film at least at part of the inkjet head 303, the wiring substrate 302 and the adhesive film 701.

### Example 4

Now, the method of bonding an inkjet head 303 and a wiring substrate 302 according to the present invention will be described in detail by way of Example 4.

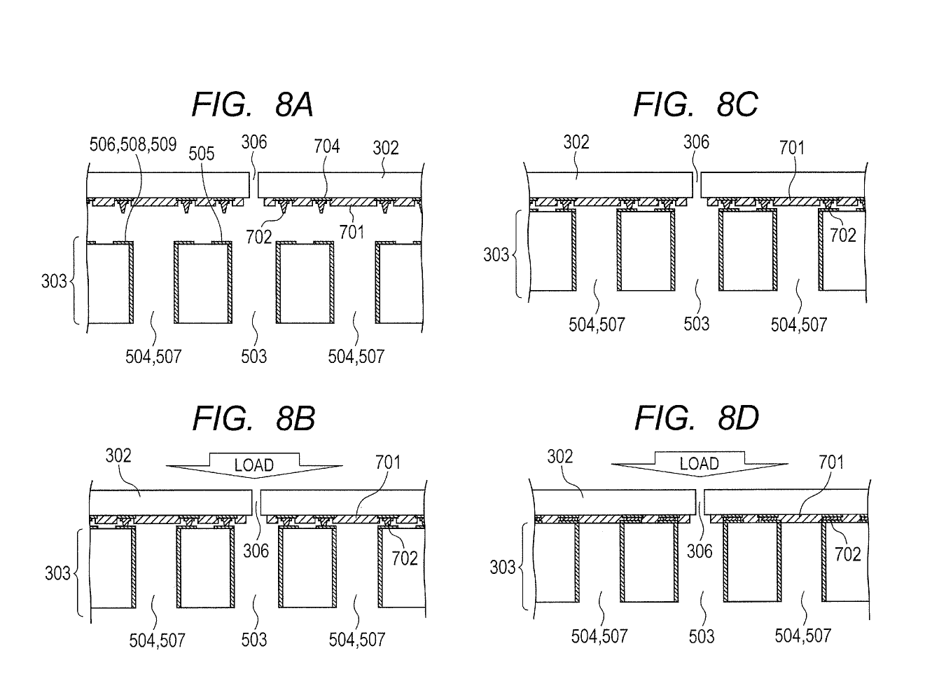

FIGS. 8A through 8D are schematic cross-sectional partial views explaining the manufacturing method related to Example 4. In the step illustrated in FIG. 8B, the connection terminals 702 that have been formed on the wiring substrate 302 by thermocompression or ultrasonic bonding are electrically connected to the respective corresponding electrodes 505, which are individual electrodes, and also to the electrodes 506, 508 and 509 that are common electrodes. However, at the time of executing the step illustrated in FIG. 8B, the adhesive film 701 is held in a state of not being bonded to the inkjet head 303. Thereafter, in the step illustrated in FIG. 8C, the load and the heat that are applied in the step illustrated in FIG. 8B are removed. In the case of ultrasonic bonding, the application of ultrasonic waves is also terminated and the room temperature is restored. Subsequently, in the step illustrated in FIG. 8D, the adhesive film 701 and the inkjet head 303 are bonded to each other by thermo-compression and, simultaneously, the adhesive film 701 is cured. At this time, the connection terminals 702 need to be further deformed from the state illustrated in FIG. 8C so as to be brought into a crushed state because the adhesive film 701 and the inkjet head 303 have to be tightly and securely bonded to each other. In the case of photosensitive adhesive film such as the one represented in Example 1, the requirements to be met for curing the adhesive film include application of a heating temperature between about 150° C. and about 200° C. for about 1 to 3 hours.

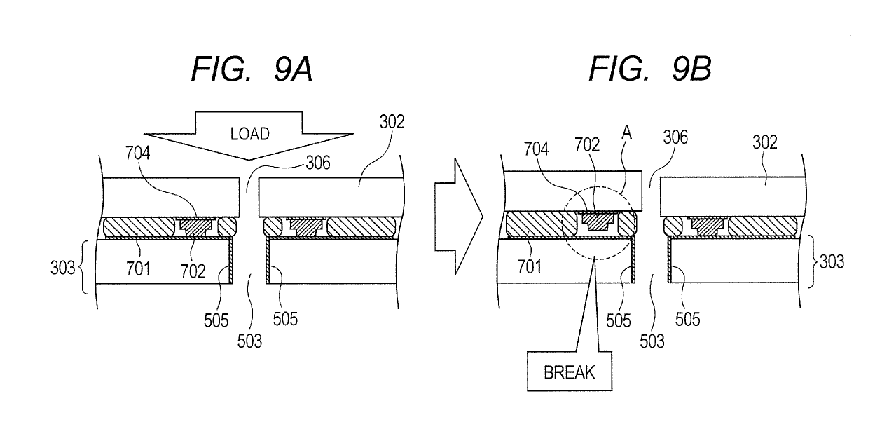

Now, the reason why the adhesive film 701 is held in a state of not being bonded to the inkjet head 303 in the step illustrated in FIG. 8B will be described below by referring to FIGS. 9A and 9B. FIG. 9A is an enlarged view of two of the connection terminals 702 illustrated in FIGS. 8B and 8C, illustrating how they are bonded as the adhesive film 701 is heavily pressed against the inkjet head 303 by a load applied to it and deformed to a large extent. When the adhesive film 701 is bonded in this way and the load for the bonding is removed, there can arise a phenomenon where one or more than one of the connection terminals 702 are broken and fail to establish electrical connection there, as represented by area A in FIG. 9B. Such a phenomenon occurs because the adhesive film 701 elastically restores its original state when the load for the bonding is removed. Such restoration of the original state is referred to spring back. Thus, one or more than one connection terminals 702 become broken when the stress caused by the spring back becomes greater than the bonding stress between the electrode of the connection terminal 702, or each of the electrodes of the connection terminals 702, and the corresponding electrode of the inkjet head 303. To avoid the breakage, the bonding step is preferably conducted so as to establish electrical connection between the connection terminals 702 and the inkjet head 303, while the adhesive film 701 and the inkjet head 303 are held in a state of not being bonded to each other (see FIG. 8B).

Note that the adhesive film 701 and the inkjet head 303 are not brought into contact with each other in the bonding step illustrated in FIG. 8B. However, they may be brought into contact in the bonding step. More specifically, the bonding step may be conducted in a state where the adhesive film 701 and the inkjet head 303 are held in contact with each other provided that the electrical connection between the connection terminals 702 and the inkjet head 303 is maintained. Alternatively, in the step illustrated in FIG. 8B, the load and the temperature for establishing electrical connection between the connection terminals 702 and the inkjet head 303 and bringing the adhesive film 701 and the inkjet head 303 into satisfactorily tight contact with each other may be continuously applied until the adhesive film 701 is cured. Then, the adhesive film 701 can be prevented from springing back. When productivity is taken into consideration, however, the time to be spent for the step illustrated in FIG. 8B should be minimized and a plurality of wiring substrates 302 and a plurality of inkjet heads 303 are desirably processed simultaneously. The reason for this is that, while the bonding apparatus that is operated for the step illustrated in FIG. 8B is a sophisticated apparatus comprising an alignment mechanism, the bonding apparatus that is operated for the step illustrated in FIG. 8D may be a simple apparatus that is required only to apply heat and a load but not required to comprise any alignment mechanism.

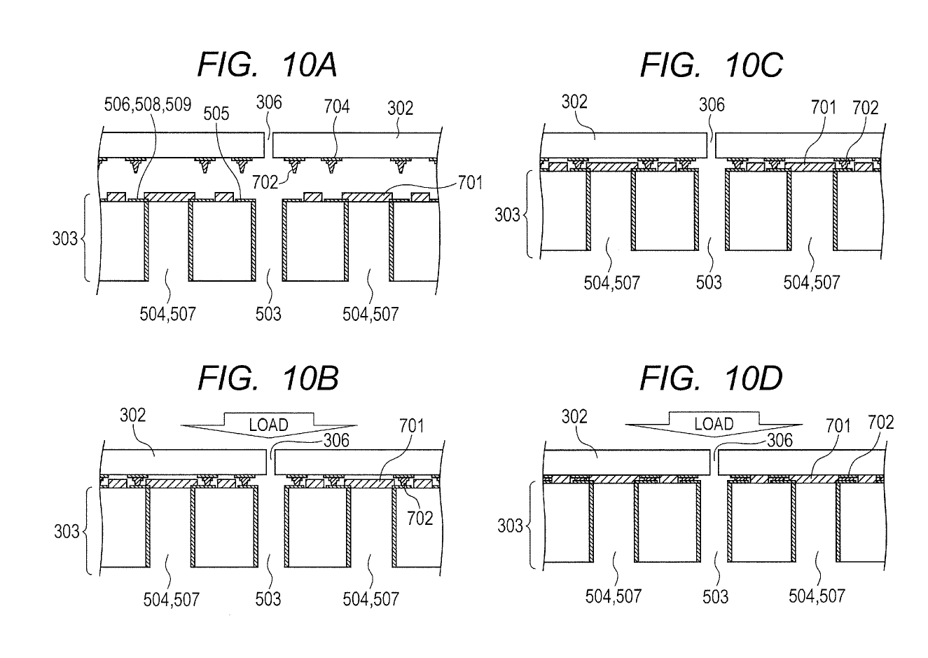

While adhesive film 701 is formed on the wiring substrate 302 with the manufacturing method illustrated in FIGS. 8A through 8D, adhesive film 701 may alternatively be formed on the inkjet head 303 by using the manufacturing method illustrated in FIGS. 10A through 10D.

### Example 5

Now, the method of bonding an inkjet head 303 and a wiring substrate 302 according to the present invention will be described in detail by way of Example 5.

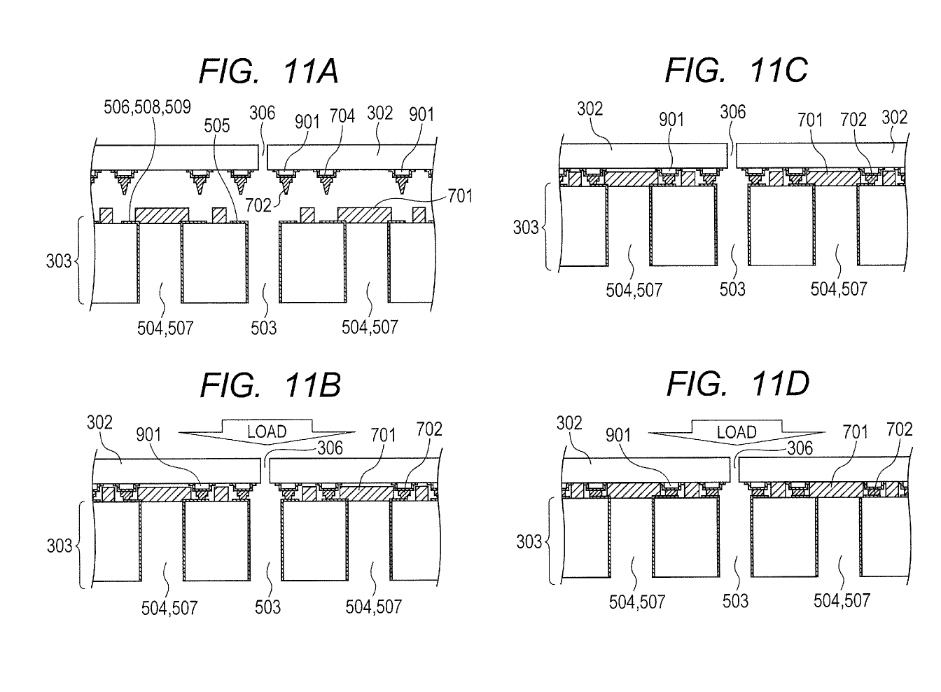

FIGS. 11A through 11D are schematic cross-sectional partial views explaining the manufacturing method related to Example 5. In this example, pedestal structures 901 are formed on the wiring substrate 302 at positions where connection terminals 702 are to be respectively formed for the purpose of supporting the base ends of the connection terminals 702. An electrode (connection terminal pad) 704 and a connection terminal 702 are formed on each pedestal structure 901. As pedestal structures are provided, the adhesive film 701 and the wiring substrate 302 can be arranged so as not to contact with each other if one or more than one of the connection terminals 702 are crushed to an extent greater than the extent to which one or more than one of the connection terminals 702 can be crushed in Example 4 in the bonding step illustrated in FIG. 11B. Then, the adhesive film 701 can be prevented from springing back. Therefore, when compared with Example 4, a heavier load can be applied and ultrasonic waves can be applied to a higher degree of intensity to allow a broader process margin to be provided as bonding condition. As a heavier load can be applied, the electrodes of the connection terminals 702 and the corresponding electrodes on the inkjet head 303 can be diffusively bonded together with ease. If, for example, the connection terminals 702 are Au bumps and the corresponding electrodes are also made of Au, the bonding strength can be raised because the cross-sectional area of the bonding sections of the connection terminals 702 is increased. Then, as a result, the reliability of the electrical connection between the wiring substrate 302 and the inkjet head 303 can be enhanced.

Either an insulating material or an electrically conductive material may be employed as material for forming the pedestal structures 901. Note, however, the connection terminals 702 need to be electrically insulated from each other when they are made of an electrically conductive material. Additionally, since the material for forming the pedestal structures 901 takes a role of defining the height of the pedestals at the time of conducting the bonding step, a material representing a rigidity greater than that of the connection terminals 702 under the bonding conditions may suitably be employed for forming the pedestal structures 901. Specific methods for forming the pedestal structures 901 include a method that involves plating, using Au, Ag, Al, Cu, Ni or the like, when an electrically conductive material is employed for forming the pedestal structures 901. When, on the other hand, the pedestal structures 901 are formed by using an insulating material, there arises the need of bonding the pedestal structures 902 to the wiring substrate 302 if the material is different from the material of the wiring substrate 302. Therefore, both the pedestal structures 901 and the wiring substrate 302 are preferably made of the same material.

An Si substrate seems to suitably be used for forming wiring substrate 302 because a drive IC and a micro-wiring pattern need to be formed there. When this is taken into consideration, conceivable suitable methods for forming the pedestal structures 901 include dry etching that relies on RIE (reactive ion etching) and wet etching (anisotropic or isotropic). The surface of the Si substrate needs to be protected by means of insulating film after forming the pedestal structures 901. Thus, SiO₂ film or SiN film will be formed on the surface of the Si substrate by means of thermal oxidation, CVD or some other technique.

A pattern of adhesive film 701 is formed on the inkjet head 303 with the manufacturing method illustrated in FIGS. 11A through 11D. However, a pattern of adhesive film 701 may alternatively be formed on the wiring substrate 302.

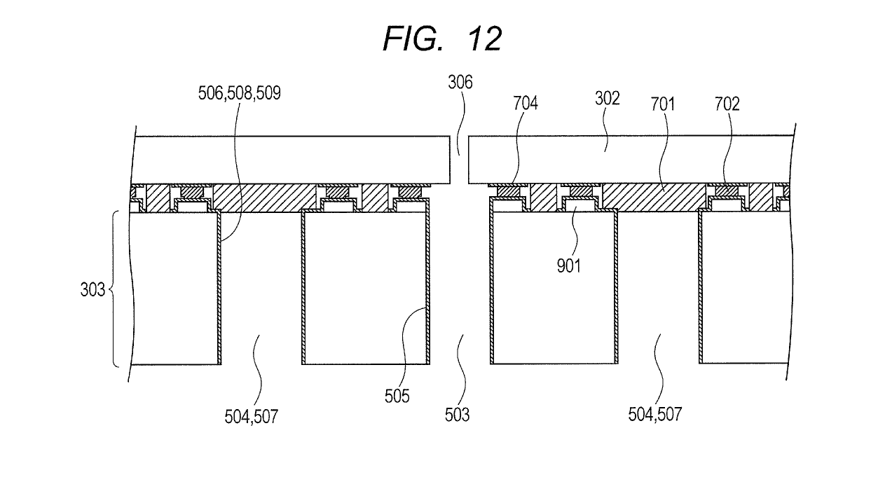

FIG. 12 illustrates a structure where pedestal structures 901 are formed on the inkjet head 303 and subsequently the wiring substrate 302 is bonded to the inkjet head 303. With such an arrangement, the pedestal structures 901 desirably represent characteristics similar to those of the pedestal structures 901 illustrated in FIGS. 11A through 11D. When the pedestal structures 901 are formed by using an electrically conductive material, a method that involves plating may suitably be employed. When, on the other hand, the pedestal structures 901 are formed by using an insulating material, the use of a method of forming them by cutting or laser machining the piezoelectric body itself that is employed to form the inkjet head 303 seems to be desirable.

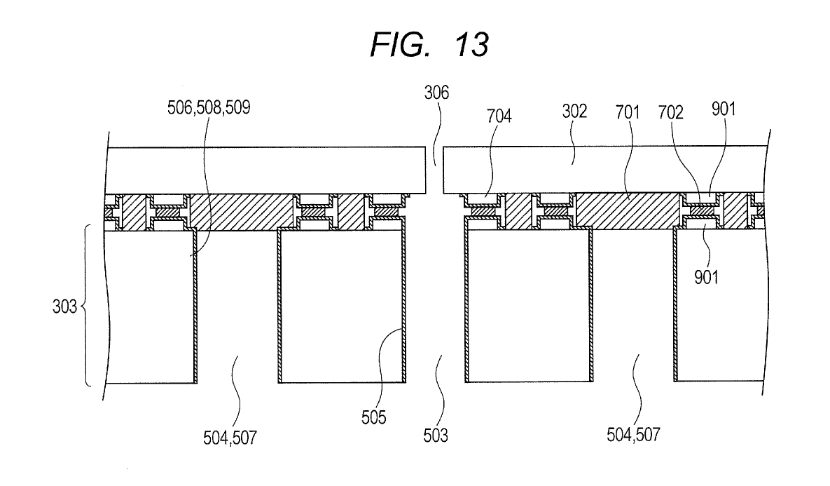

Pedestal structures 901 may be formed on both the wiring substrate 302 and the inkjet head 303 as illustrated in FIG. 13. Thus, the above-described advantages can be obtained by forming pedestal structures 901, which are to be brought into contact with corresponding respective connection terminals 702, on the wiring substrate 302 at positions located vis-a-vis the connection terminals 702 and/or on the inkjet head 303 also at positions located vis-à-vis the connection terminals 702. Regardless if the arrangement of FIG. 12 or that of FIG. 13 is chosen, the adhesive film 701 may be formed either on the wiring substrate 302 or on the inkjet head 303.

### Example 6

Now, the method of bonding an inkjet head 303 and a wiring substrate 302 according to the present invention will be described in detail by way of Example 6.

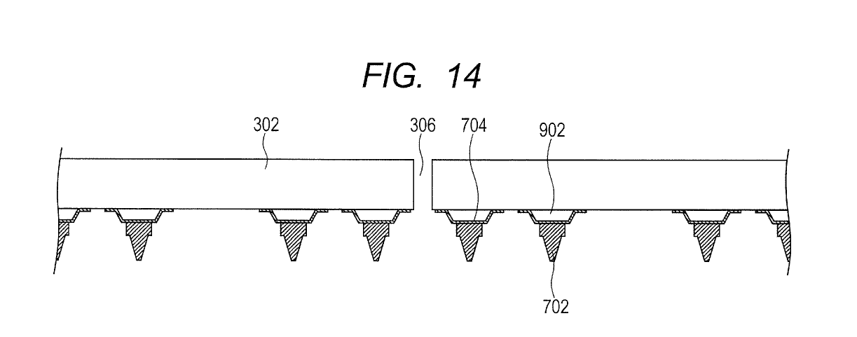

FIG. 14 is a schematic cross-sectional view of the wiring substrate 302 for illustrating Example 6. In Example 6, pedestal structures 901 as represented in Example 5 are also formed at positions that correspond to the connection terminals 702. The pedestal structures 901 of Example 6, however, represent a tapered profile as illustrated in FIG. 14. When the pedestal structures 901 are formed by using an insulating material, connection terminals pads 704 to be connected to the connection terminals 702 and a wiring pattern to be arranged around the pedestal structures 901 need to be formed on the pedestal structures 901 by sputtering, vapor deposition or some other means. When the lateral walls of the pedestal structures 901 are formed so as to stand perpendicularly relative to the bonding surfaces of the wiring substrate 302 and the inkjet head 303, they are apt to produce areas that are free from metal film after metal film is formed to cover the lateral walls. Similarly, when the lateral walls of the pedestal structures 901 are formed so as to be inclined relative to the bonding surfaces of the wiring substrate 302 and the inkjet head 303 such that the pedestal structures 901 are tapered toward the ends thereof that are opposite to the ends to be brought into contact with the connection terminals 702 and hence the cross-sectional area of the pedestal structures 901 is gradually reduced toward those ends, they are also apt to produce areas that are free from metal film after metal film is formed to cover the lateral walls. In either instance, the electrical connection between the connection terminal pads 704 formed on the tops of the pedestal structures 901 and the wiring pattern arranged around the pedestal structures 901 is liable to be broken. Therefore, the lateral walls of the pedestal structures 901 are formed so as to be inclined relative to the bonding surfaces of the wiring substrate 302 and the inkjet head 303 such that the pedestal structures 901 are tapered toward the ends thereof that are to be brought into contact with the connection terminals 702 and hence the cross-sectional area of the pedestal structures 901 is gradually increased toward the ends opposite to the above ends. As the pedestal structures 901 are made to represent such a tapered profile, metal film can reliably be formed on the entire surfaces of the lateral walls of the pedestal structures 901. With this arrangement, the electrical connection between the connection terminal pads 704 connected to the connection terminals 702 and the wiring pattern arranged around the pedestal structures 901 is prevented from being broken on any of the lateral walls of the pedestal structures 901.

With the arrangement illustrated in FIG. 14, the pedestal structures 901 are formed on the wiring substrate 302. However, pedestal structures 901 may alternatively be formed on the inkjet head 303 at positions located vis-à-vis the connection terminals. This alternative arrangement equally provides the above-described advantages that are obtained by forming the pedestal structures 901 so as to represent the above-described profile.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of the Japanese Patent Application No. 2013-118726, filed Jun. 5, 2013, which is hereby incorporated by reference herein in its entirety.

What is claimed is:

1. A method of manufacturing a liquid ejecting device equipped with a liquid ejection head comprising a pressure chamber communicating with an ejection port for ejecting liquid and having an opening for introducing liquid to be ejected from the ejection port and a plurality of air chambers separated from the pressure chamber, a piezoelectric body being arranged between the pressure chamber and at least one of the air chambers, a pair of electrodes being provided, one on the wall of the pressure chamber and the other on the wall of the at least one of the air chambers so as to sandwich the piezoelectric body, the liquid ejection head being so constructed as to eject liquid from the ejection port by applying a voltage between the pair of electrodes and causing the piezoelectric body to expand and contract, the method comprising:
bonding a wiring substrate having a connection terminal to be electrically connected to the electrode provided on the wall of the pressure chamber, wiring extending from the connection terminal and a through hole representing a cross-sectional area smaller than the cross-sectional area of the opening and formed at a position corresponding to the opening to a bonding surface of the liquid ejection head arranged at the side of the opening by means of an adhesive film; and
electrically connecting the connection terminal of the wiring substrate and the electrode provided on the wall of the pressure chamber of the liquid ejection head.

2. The method according to claim 1, wherein
the wiring substrate has a second connection terminal, and the second connection terminal is electrically connected to the electrode provided on the wall of the at least one of the air chambers.

3. The method according to claim 1, wherein
the wiring substrate has a through electrode for drawing out the wiring to a surface opposite to the bonding surface to be bonded to the liquid ejection head.

4. The method according to claim 1, wherein
a film of a paraxylylene based polymer is formed on at least part of the liquid ejection head, the wiring substrate and the adhesive film after the liquid ejection head and the wiring substrate are bonded by means of the adhesive film.

5. The method according to claim 1, wherein
the wiring substrate and the liquid ejection head are bonded by means of the adhesive film after the connection terminal and the electrode on the wall of the pressure chamber are electrically connected.

6. The method according to claim 1, wherein
the wiring substrate and the liquid ejection head are bonded by way of the connection terminal and the adhesive film so as to make the thickness of the connection terminal after the bonding not greater than the thickness of the adhesive film after the bonding.

7. The method according to claim 1, wherein
a pedestal structure to be brought into contact with the connection terminal is formed at least either at the position of the connection terminal on the wiring substrate or at the position on the liquid ejection head squarely facing the connection terminal.

8. The method according to claim 7, wherein
the pedestal structure is formed to represent a profile with which the area of the cross section of the pedestal structure running in parallel with the bonding surfaces of the wiring substrate and the liquid ejection head continuously increases from the end thereof to be brought into contact with the connection terminal toward the other end.
